(19) United States
(12) Patent Application Publication
(10) Pub. No.: US 2019/0361237 A1
(43) Pub. Date: Nov. 28, 2019

(54) HEAD-UP DISPLAY DEVICE

(71) Applicant: GM GLOBAL TECHNOLOGY OPERATIONS LLC, Detroit, MI (US)

(72) Inventors: Peter Brandt, Aschaffenburg (DE); Holger Wolf, Essenheim (DE); Heiko Charle, Ruesselsheim (DE); Andreas Kreis, Schornsheim (DE)

(73) Assignee: GM GLOBAL TECHNOLOGY OPERATIONS LLC, Detroit, MI (US)

(21) Appl. No.: 15/989,223

(22) Filed: May 25, 2018

(51) Int. Cl. G02B 27/01; G02B 27/64

(52) U.S. Cl. CPC G02B 27/0149; G02B 27/646

(57) ABSTRACT

The present disclosure relates to a head-up display device for a vehicle, having a projection device for projecting information onto a projection surface of the vehicle, and a control unit for switching on and off the light emission of the projection device with pulse-width modulation (PWM), at a control frequency f_{A}. The control unit is configured to determine a excitation frequency f_{E} and to adjust the control frequency f_{A} according to the determined excitation frequency f_{E}.

### TECHNICAL FIELD

The present disclosure relates to a head-up display device for a vehicle, primarily in the context of a motor vehicle such as an automobile but also in the context of an aircraft or watercraft.

### BACKGROUND

Various heads-up display devices are generally known for displaying information to a user, in particular a vehicle driver, on a transparent panel such as a windshield of the vehicle. If the vehicle, the head-up display device, or its holder vibrates due to certain operating conditions such as certain vehicle speeds or engine speeds, the projected image may also vibrate and thus appear blurred in the user's field of view. Apart from the fact that the recognizability or readability of the information is impacted, this can lead to a negative psychological and/or physiological effect for the viewer. For example, a vehicle driver may be irritated and/or distracted, may fatigue more quickly, or even feel nauseous.

Accordingly, there is a need in the art to reduce or prevent the effects of vibrating image projections.

### SUMMARY

The present disclosure recognizes fact that engine vibrations or external excitations such as air currents may excite the vehicle or parts of the vehicle at or near a resonant frequency, typically in the range from 30 to 120 Hz, which induces vibrations. Such vibrations can have a direct or indirect effect on the head-up display device, with the result that the projected image which is generated and projected onto the windshield or another projection surface vibrates at the excitation frequency of these vibrations. The present disclosure further recognizes that the most objectionable vibrations of the projection image are vertically oriented, but may, to a lesser extent include lateral or longitudinal directions depending on local conditions. Perception of these vibrations by the viewer may be significantly reduced by periodically and/or cyclically switching the generated projected image on and off at the excitation frequency, or a multiple thereof.

Accordingly, the present disclosure provides a solution to the undesirable vibration of image projections in a head-up display including a control unit configured to stroboscopically display the projected image at a control frequency f_{A} as a function of an excitation frequency f_{E}. In order to affect a stroboscopic display, the control unit is also configured to determine the excitation frequency and the control frequency. As a result, the projected image is projected at the same position according to the determined excitation frequency and otherwise turned off so that it appears to in the user's field of view as a stationary image that does not vibrate, thereby preventing the above-noted impairments for the viewer of the projected information. According to the present disclosure, the projected image is thus turned off over large portions of the vibration amplitude, and is only switched on (i.e., projected or displayed) during short pulses or phases, such that the subjective impression of a stationary projected image is created. The switched-on duration may be the repetition rate of the PWM signal having a control frequency f_{A} corresponding to the excitation frequency f_{E}. The control frequency f_{A} of the PWM signal is a function of the excitation frequency f_{E} or as expressed in an equation: f_{A}=n·f_{E}, where n=i or 1/i and i is a whole number (e.g., i=1, 2, 3, 4, . . . ).

According to an embodiment of the present disclosure, at least one sensor, typically configured as an accelerometer, measures a vibration response of the vehicle or a part thereof. The sensor may be configured to measure the vibration response for a component of the head-up display device for directly detecting the vibrations of the device itself as precisely as possible. Alternatively, one or more sensors which are present for other purposes can also be used for indirectly detecting the vibrations of the display device, in which case a transfer function is used to correlated the measured vibration with the vibration behavior at the head-up display device to arrive at a determined vibration.

According to an embodiment of the present disclosure, the device according to the present disclosure includes at least one data table having control data stored therein for driving conditions such as a driving speed, an engine speed or a combination thereof. This embodiment eliminates the use of a sensor for measuring a vibration response and has been found to be effective when there is a strong correlation between a driving state and the vibration behavior of the display device for a particular head-up display device in the vehicle. In this embodiment, a look-up function can be implemented with the data table to determine a transfer function or frequency response function to correlate the driving state with the vibration behavior at the head-up display device and arrive at a determined vibration. The data stored in the table preferably includes the excitation frequency and amplitude present in each driving state for determining the transfer function.

According to an embodiment of the present disclosure, the device is configured to switch on the projection device at a vibration extreme (maximum or minimum), and to otherwise switch it off. This approach takes into account the fact that, at the vibration maxima or minima, the rate of change in movement of the projected image is less pronounced than in the other vibration regions, and therefore the projection device can remain activated for a longer duration, therefore achieving a higher luminance such that the projected image appears brighter. In such a case, the excitation frequency f_{E} and the phase position for a determined vibration, as well as the sampling rate of the PWM signal are determined. The phasing of the PWM signal is such that the projection device is switched on at a vibration extreme based on the phase position of the determined vibration. As an alternative to the activation of the projection device at the extremes, it is possible to use two shorter activation periods with the same amplitude value within a vibration period.

The term ‘determined vibrations’ in this context can mean directly-measured vibrations, or data calculated or stored in tabular form on the basis of other driving state data.

According to an embodiment of the present disclosure, the device according to the present disclosure is connected to external sensors for determining the vibrations. In this way, the structural complexity for the device according to the present disclosure is reduced, since such sensors are already regularly present in a vehicle.

The present disclosure also provides a motor vehicle which includes a head-up display device according to one of the embodiments described above. The present disclosure further provides a method for operating a head-up display device for a vehicle, having a projection device for projecting information onto a projection surface of the vehicle. The projection device is controlled by pulse width modulation (PWM) with a control frequency f_{A}. An excitation frequency f_{E} of the head-up display device is determined and the control frequency f_{A} is adjusted according to the determined excitation frequency f_{E}.

Further advantages, features and details emerge from the following description, in which at least one exemplary embodiment is described in detail, with reference to the drawings. Identical, similar and/or functionally identical parts are indicated by the same reference numbers.

### BRIEF DESCRIPTION OF THE DRAWINGS

The present disclosure will hereinafter be described in conjunction with the following drawing figures, wherein like numerals denote like elements.

FIG. 1 shows a schematic representation of a head-up display device;

FIG. 2 shows a functional diagram of the head-up display device; and

FIG. 3 shows a diagram with vibrational oscillations.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

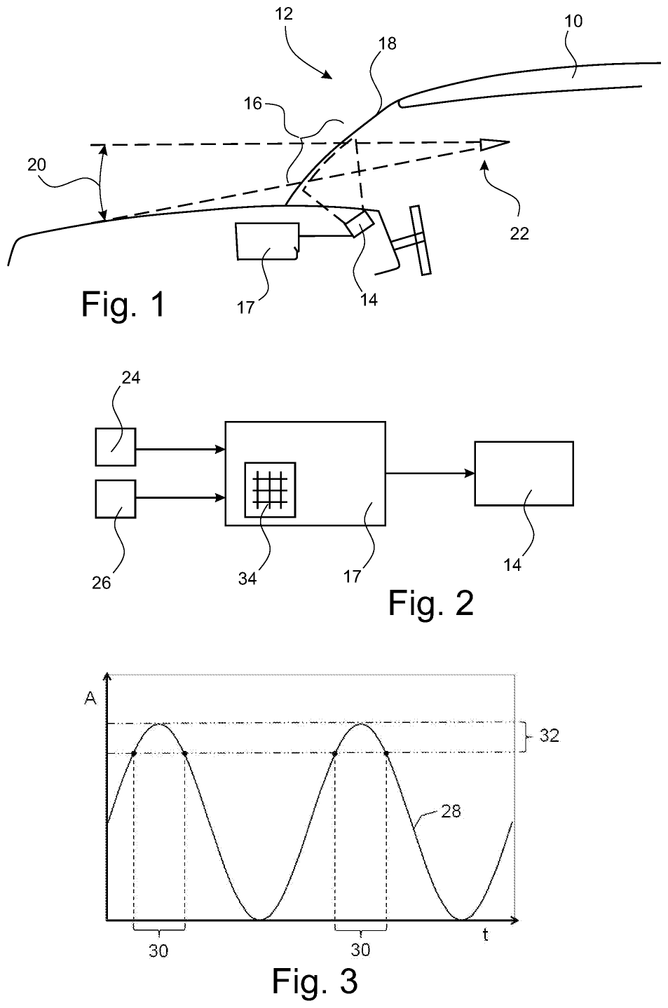

FIG. 1 schematically shows a detailed view of a motor vehicle 10 having a head-up display device 12. The head-up display device includes a projection device 14 that projects an image 16 onto a region of a windshield 18 located in a visual field 20 of the eyes 22 of a vehicle driver. The projection device 14 is controlled by a control unit 17 using a pulse-width-modulated signal (PWM signal) to cyclically switch the projection device on for a period which corresponds to the pulse-width repetition rate (between 0 and 100%) of the PWM signal, thereby stroboscopically displaying a projected image. At a pulse-width repetition rate of 100%, the projection device 14 remain on over the entire pulse width (i.e., constantly on) such that a projected image 16 may vibrate in response to the excitation frequency. At a pulse-width repetition rate significantly less than 50%, such vibrations may be less noticeable. The projection device 14 is preferably an LCD display, an OLED display or a VFD display.

FIG. 2 shows a functional diagram of the head-up display device 12, which is connected to a vibration sensor 24 and/or a driving state data generator 26. In a first embodiment, the vibration sensor 24 is arranged in local proximity to the head-up display device 12, and thus is operable to sense or detect a vibration response of the head-up display device 12 to an excitation frequency. Alternatively, the vibration sensor 24 may be a component of other control devices present in the vehicle and is operable to sense or detect a vibration response associated with the other control devices or the vehicle in general. According to the frequency and the amplitude of such vibration response, an example of which is shown in FIG. 3, the control unit 17 modulates the projection device 14 on and off synchronously in response to such vibration response.

FIG. 3 shows an simplified time plot (time v. amplitude) of a fundamental (i.e., a first vibration mode) vibration response 28 for the projected image 16, which is approximately sinusoidal and with an amplitude depending on the resonance behavior. One skilled in the art will recognize that the vibration response curve will likely include multiple vibration modes across a range of frequencies. When the excitation frequency deviates significantly from a resonance frequency of the head-up display device 12, the amplitude will be considerably less than near the resonance frequency. Without corrective measures, the projected image 16 could visibly vibrate in the driver's field of view 20, and lead to impairments in the readability of the displayed information.

The control unit 17 controls the illumination intensity of the projection device 14 by means of the PWM signal with a phase position, such that, in the embodiment shown, the projected image is projected onto the windshield 18 about the vibration maxima 30, whereas the projected image 16 remains off in the intervening periods. In this way, the effective vibration amplitude 32 of the display image 16 is considerably reduced, and appears to the viewer essentially as a stationary image.

Alternatively or in addition to the vibration sensor 24, in the illustrated embodiment, a driving state data generator 26 is included which supplies data, such as the vehicle speed or the engine speed, to the control unit 17. The control unit 17 in this case contains a stored table 34 in which vibration values of the projection device 14 with respect to the frequency and amplitude determined by previous vehicle type-specific tests are stored for this driving state data. This makes it possible to control the projected image 16 in the manner according to the present disclosure, even without a vibration sensor.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A head-up display device for a vehicle comprising:
a projection device for projecting information onto a projection surface of the vehicle; and
a control unit operably coupled to the projection device and configured to:
determine a excitation frequency f_{E};
adjust a control frequency f_{A} according to the determined excitation frequency f_{E}; and
stroboscopially display information onto the projection surface by switch on and off light emission of the projection device with pulse-width modulation at the a control frequency f_{A}.

2. The device according to claim 1, wherein the control unit configured to receive vibration data from at least one vibration sensor and determine the excitation frequency f_{E} based on the vibration data.

3. The device according to claim 1, wherein the control unit further comprising data storage memory configured to store at least one data table having driving state data and control data, wherein the control unit determines the excitation frequency f_{E} based on the driving state data.

4. The device according to claim 3, wherein the driving state data is selected from the group consisting of engine speed data, vehicle speed data or a combination thereof.

5. The device according to claim 1, wherein the control unit is further configured to activate the projection device at a vibration extreme of the excitation frequency f_{E}.

6. The device according to claim 1, wherein the control unit is configured to adjust the control frequency at a multiple of the excitation frequency f_{E}.

7. A method for operating a head-up display device for a vehicle, having a projection device for projecting information onto a projection surface of the vehicle, the method comprising:
determine a excitation frequency f_{E} of the vehicle;
adjusting a control frequency f_{A} according to the determined excitation frequency f_{E}; and
stroboscopially displaying information onto the projection surface by switch on and off light emission of the projection device with pulse-width modulation at the control frequency f_{A}.

8. The method according to claim 7, further comprising receiving vibration data from at least one vibration sensor on the vehicle and determining the excitation frequency f_{E} based on the vibration data.

9. The method according to claim 7, further comprising determining a driving state of the vehicle, comparing the driving state to predefined driving state date and determining the excitation frequency f_{E} based on the driving state data.

10. The method to claim 9, wherein the driving state data is selected from the group consisting of engine speed data, vehicle speed data or a combination thereof.

11. The method according to claim 7, further comprising activating the projection device at a vibration extreme of the excitation frequency f_{E}.

12. The method according to claim 7, further comprising adjusting the control frequency at a multiple of the excitation frequency f_{E}.
